(19) United States
(12) Patent Application Publication
(10) Pub. No.: US 2017/0218773 A1
(43) Pub. Date: Aug. 3, 2017

(54) BLADE CASCADE AND TURBOMACHINE

(71) Applicant: MTU Aero Engines AG, Muenchen (DE)

(72) Inventors: Markus Brettschneider, Muenchen (DE); Franz Malzacher, Groebenzell (DE)

(21) Appl. No.: 15/489,323

(22) Filed: Apr. 17, 2017

Related U.S. Application Data
(62) Division of application No. 14/108,970, filed on Dec. 17, 2013.

(30) Foreign Application Priority Data
Dec. 19, 2012 (EP) 12197930.6

(51) Int. Cl. F01D 5/14

(52) U.S. Cl. CPC F01D 5/143; F01D 5/145; F05D 2240/123; F05D 2240/124

(57) ABSTRACT

A blade cascade of a turbomachine having at least one shape variation of a blade situated on the blade side in the proximity of a side wall and extending downstream, and at least one side wall contouring of the side wall or at least one second shape variation of an adjacent blade near the side wall, as well as a turbomachine, are disclosed.

This is a Divisional of U.S. patent application Ser. No. 14/108,970, filed Dec. 17, 2013 which claims the benefit of European Patent Application EP 12 197 930.6, filed Dec. 19, 2012, both of which are hereby incorporated by reference herein.

The present invention relates to a blade cascade of a turbomachine, a blade cascade of a turbomachine, and a turbomachine.

### BACKGROUND

A fluid flow guided through a flow channel is deflected by a lateral pressure gradient parallel to the side wall. Since flow layers close to the wall, due to their low speed, are deflected more than flow layers remote from the wall, a secondary flow is formed which is superimposed on a main flow. This results in pressure losses, among other things. The secondary flows typically arise in blade cascades of turbomachines such as gas turbines and steam turbines. The blade cascades are composed of a plurality of blades, situated next to one another in the peripheral direction, which are situated in a rotationally symmetrical flow channel, and between each of which a blade channel is formed in which the secondary flows originate. In the radial direction the blade channels are delimited in each case by a radially outer side wall on the housing side and by a radially inner side wall on the hub side. The side walls are formed by a stationary housing section, a rotor section, radially inner blade cover plates, and/or radially outer blade cover plates. In the peripheral direction, the blade channels are delimited in each case by a pressure side and an oppositely situated suction side of the adjacent blades.

### SUMMARY OF THE INVENTION

To reduce the secondary flows and channel turbulences, circumferentially asymmetrical contourings in the form of projections and/or impressions are frequently introduced into the side walls. Thus, for example, it is proposed in the patent applications US 2006/0233641 A1 and US 2007/0258819 A1 to provide at least one of the side walls with at least two contourings, one contouring being designed as a projection and the at least one other contouring being designed as an impression.

It is an object of the present invention to provide a blade cascade for a turbomachine having a reduced secondary flow. Moreover, an alternate or additional object of the present invention is to provide a turbomachine having improved efficiency.

A blade cascade according to the present invention of a turbomachine has a plurality of blade channels which in the peripheral direction are delimited in each case by a pressure side of a blade and by an oppositely situated suction side of an adjacent blade. In the radial direction, the blade channels are delimited in each case by two oppositely situated side walls. At least one of the side walls of the blade channels in each case is provided with at least one circumferentially asymmetrical side wall contouring in the area of one of the blades. According to the present invention, in the area of its pressure side or suction side facing the side wall contouring the other blade has at least one shape variation extending downstream, near the side wall or in the area of the side wall.

Due to the specific configuration of the blade profile or shape variation in the side wall area, the positive effect is comparable to that achieved by the side wall contouring. Thus, by combining the side wall contouring with a shape variation near the side wall on the blade side, a static pressure field at the at least one side wall and at the oppositely situated blade sides in the edge area is influenced in such a way that a secondary flow is significantly reduced. As a result, flow losses are reduced and inflow onto a subsequent blade cascade is improved. The at least one shape variation represents one specific configuration of the blade profile in the side wall area which relates to a design with and also without a fillet.

In one exemplary embodiment, the shape variation is a thickened area on the pressure side, and the at least one side wall contouring is an impression on the suction side. The thickened area is a localized surface area extension of the pressure side following the blade profile in the flow direction, and thus causes a reduction in the channel cross section on the pressure side. The thickened area preferably has a radial extension which corresponds to a maximum of 15% of a blade channel height.

The pressure-side thickened area preferably extends downstream from a leading edge on the blade side, and the suction-side impression begins upstream from a leading edge on the blade side. The impression preferably extends over or practically over the entire axial width of the suction side.

In addition, a side wall contouring in the form of a suction-side projection may be formed downstream from the impression.

In one alternative exemplary embodiment, the shape variation is an abrasion of the suction side, and the at least one side wall contouring is a projection on the pressure side. The abrasion of the blade is a localized surface area extension of the suction side following the blade profile in the flow direction, and thus causes an enlargement in the channel cross section on the suction side. The abrasion preferably has a radial extension which corresponds to a maximum of 15% of a blade channel height.

The suction-side abrasion preferably extends downstream from a leading edge on the blade side, and the pressure-side projection begins upstream from a leading edge on the blade side. The projection advantageously extends to an area which corresponds to approximately 60% of an axial blade width.

In addition, a side wall contouring in the form of a pressure-side impression may be formed downstream from the pressure-side projection. The pressure-side impression is preferably situated with its lowest section upstream from a trailing edge on the blade side.

An alternative blade cascade according to the present invention of a turbomachine has a plurality of blade channels which in the peripheral direction are delimited in each case by a pressure side of a blade and by an oppositely situated suction side of an adjacent blade. In the radial direction the blade channels are delimited in each case by two oppositely situated side walls. According to the present invention, the pressure side and the oppositely situated suction side each have at least one shape variation extending downstream, near or in the area of at least one of the side walls. Depending on the design of the shape variations, the blade channel may have a reduced cross section or an enlarged cross section compared to a blade channel without shape variations on the blade side.

The pressure-side shape variation is preferably a localized thickened area of the pressure side, and the suction-side shape variation is preferably an abrasion of the oppositely situated suction side.

A preferred turbomachine has at least one blade cascade according to the present invention. Due to the reduced secondary flows and channel turbulences, this type of turbomachine has improved efficiency compared to a turbomachine having a conventional blade cascade.

### BRIEF DESCRIPTION OF THE DRAWINGS

Preferred exemplary embodiments of the present invention are explained in greater detail below with reference to schematic illustrations.

FIG. 1 shows an exposed peripheral section of a first exemplary embodiment of a blade cascade according to the present invention;

FIGS. 2a and 2b show sectional views of alternative shape variations along line A-A in FIG. 1;

FIG. 3 shows an exposed peripheral section of a second exemplary embodiment of the blade cascade according to the present invention;

FIG. 4 shows an exposed peripheral section of a third exemplary embodiment of the blade cascade according to the present invention;

FIGS. 5a and 5b show sectional views of alternative shape variations along line B-B in FIG. 2,

FIG. 6 shows an exposed peripheral section of a fourth exemplary embodiment of the blade cascade according to the present invention, and

FIG. 7 shows an exposed peripheral section of one exemplary embodiment of a further blade cascade according to the present invention.

### DETAILED DESCRIPTION

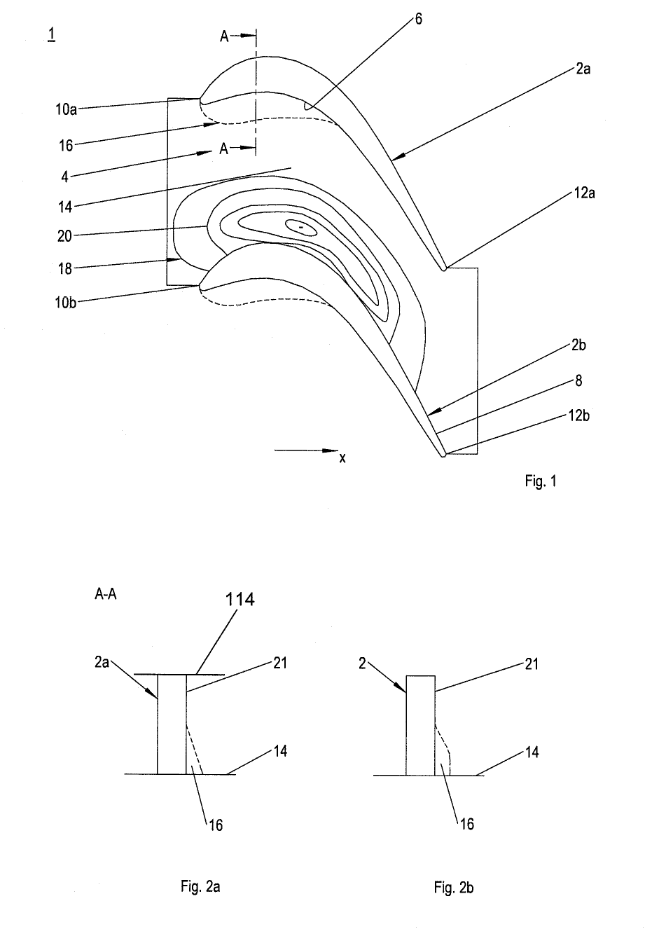

As shown in the first exemplary embodiment according to FIG. 1, a blade cascade 1 according to the present invention has a plurality of blades 2a, 2b which are situated next to one another in the peripheral direction of blade cascade 1 and which in each case delimit a blade channel 4. Blade cascade 1 is preferably a blade cascade of an axial turbomachine such as an aircraft engine or a stationary gas turbine. For example, blade cascade 1 is situated in the low-pressure turbine of the turbomachine.

Blade cascade 1 is situated concentrically with respect to a machine axis or rotor axis, not shown, which extends in axial direction x. According to the illustration in FIG. 1, a main flow, not shown, flows through the blade cascade from left to right, the main flow in blade channels 4 being correspondingly deflected in the peripheral direction.

In the peripheral direction, each blade channel 4 is delimited by a pressure side 6 of first blade 2a and by an oppositely situated suction side 8 of second blade 2b, the first blade and the second blade in each case extending between a leading edge 10a, 10b and a trailing edge 12a, 12b of blades 2a, 2b, respectively. In axial direction x, each blade channel 4 is delimited by leading edges 10a, 10b and by trailing edges 12a, 12b, respectively. In the radial direction, each blade channel 4 is delimited by a hub-side or inner side wall 14. In addition, each blade channel 4 is delimited in the radial direction by a housing-side or outer side wall 114, shown solely schematically in FIG. 2a, situated opposite from the inner side wall. Inner side wall 14 is formed, for example, by a rotor section or a platform on the blade root side. The outer side wall is formed, for example, by a housing section or an outer shroud on the blade tip side, and may have the same design as inner side wall 14.

At least inner side wall 14 is provided with a circumferentially asymmetrical side wall contouring 18, and with an oppositely situated pressure-side shape variation 16 of pressure side 6.

Side wall contouring 18 is a suction-side impression in the form of a trough. The side wall contouring is graphically depicted by a plurality of depth contour lines 20, its maximum or deepest section being provided with a minus sign. The side wall contouring begins upstream from leading edge 10b and extends approximately over the entire axial width of blade 2b. The deepest section of the side wall contouring is situated at a distance from suction side 8 in the peripheral direction. The deepest section preferably has a small area, and is oval in particular.

Pressure-side shape variation 16 is a thickened area of pressure side 6 which extends downstream from leading edge 10a to approximately 50% of the axial width of blade 2a. Thickened area 16 preferably has a radial extension of up to approximately 15% of a blade channel height, measured from side wall 14. As indicated by the dashed line, the thickened area has a profile-like curve and is formed on pressure side 6, near side wall 14. Due to its extension into blade channel 4, the thickened area causes a reduction in the channel cross section in the area near the side wall.

As shown in FIG. 2a, thickened area 16 has a triangular cross section in one exemplary embodiment. The greatest extension of the thickened area into blade channel 4 is directly at side wall 14. In the radial direction of blade cascade 1 or of the turbomachine, the cross-sectional area of thickened area 16 is linearly reduced, and then gradually merges into an original pressure side curve 21 of blade 2a outside the side wall area.

FIG. 2b shows one exemplary embodiment in which thickened area 16 extends perpendicularly with respect to side wall 14, and via a curved section having one inflection point, for example, merges into an unchanged pressure side curve 21 of blade 2a outside the side wall area.

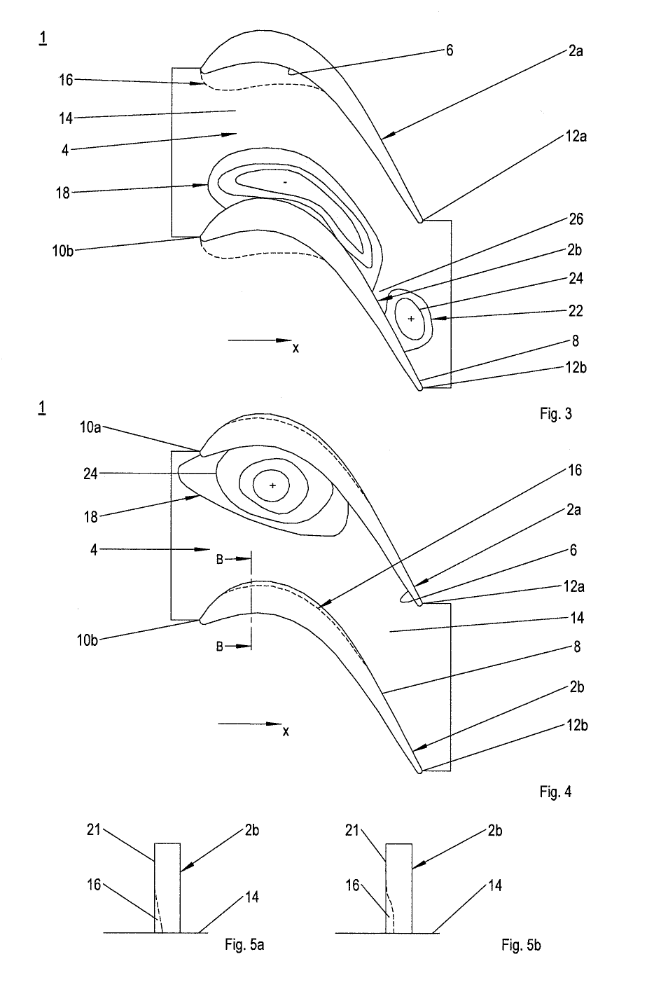

In the second exemplary embodiment of blade cascade 1 shown in FIG. 3, a second side wall contouring 22 is provided in a blade channel 4 between two blades 2a, 2b in addition to suction-side side wall contouring 18 in the form of an impression and pressure-side shape variation 16 in the form of a thickened area.

In contrast to the first exemplary embodiment according to FIG. 1, suction-side impression 18 begins downstream from leading edge 10b of second blade 2b. The deepest section of the suction-side impression, situated at a distance from suction side 8, has a large area and in particular is arc-shaped.

Pressure-side thickened area 16 in the second exemplary embodiment has the same design as pressure-side thickened area 16 in the first exemplary embodiment according to FIGS. 1, 2a, and 2b.

Second side wall contouring 22 is a suction-side projection. The second side wall contouring is graphically depicted by height contour lines 24, its highest section being provided with a plus sign. The highest section of the second side wall contouring is situated at a distance from suction side 8, and is thus a hill. In the second exemplary embodiment shown, the hill is slightly cone-shaped in the top view. Suction-side projection 22 is separated at a distance from suction-side impression 18 via a non-contoured or contour-free side wall section 26, and ends approximately at the same axial position as trailing edges 12a, 12b of blades 2a, 2b, respectively. The highest section of the suction-side projection, indicated by a plus sign, is preferably situated essentially upstream from the axial position of trailing edges 12a, 12b. The highest section preferably has an oval plateau surface area.

In the third exemplary embodiment of blade cascade 1 according to the present invention shown in FIG. 4, at least one inner side wall 14 is provided with a circumferentially asymmetrical pressure-side side wall contouring 18 and with an oppositely situated suction-side shape variation 16 of blade 2b in a blade channel 4 between two blades 2a, 2b.

Side wall contouring 18 is graphically depicted by height contour lines 24. The maximum or highest section of the side wall contouring, indicated by a plus sign, is situated at a distance from pressure side 6 in the peripheral direction, and thus is designed as a hill. The side wall contouring begins upstream from leading edge 10a, and extends to approximately 50% of the axial width of blade 2a. The highest section preferably has a circular plateau surface area.

Shape variation 16 is an abrasion which is introduced into suction side 8 and which extends downstream from leading edge 10b in an area of approximately 10% to 75% of an axial blade width. Abrasion 16 preferably has a radial extension of up to approximately 15% of a blade channel height, measured from side wall 14. As indicated by the dashed line, the abrasion has a profile-like curve and is formed on suction side 8, near side wall 14. Due to its extension into blade channel 4, the abrasion causes an enlargement in the channel cross section in the area near the side wall.

As shown in FIG. 5a, abrasion 16 has a triangular cross section in one exemplary embodiment. The greatest extension of the abrasion is into suction side 8 or into blade 2b directly at side wall 14. In the radial direction of blade cascade 1 or of the turbomachine, the cross-sectional area of abrasion 16 is linearly reduced, and then gradually merges into an original pressure side curve 21 of blade 2b outside the side wall area.

FIG. 5b shows one exemplary embodiment in which abrasion 16 extends perpendicularly with respect to side wall 14, and via a curved section having one inflection point, for example, merges into unchanged pressure side curve 21 of blade 2b outside the side wall area.

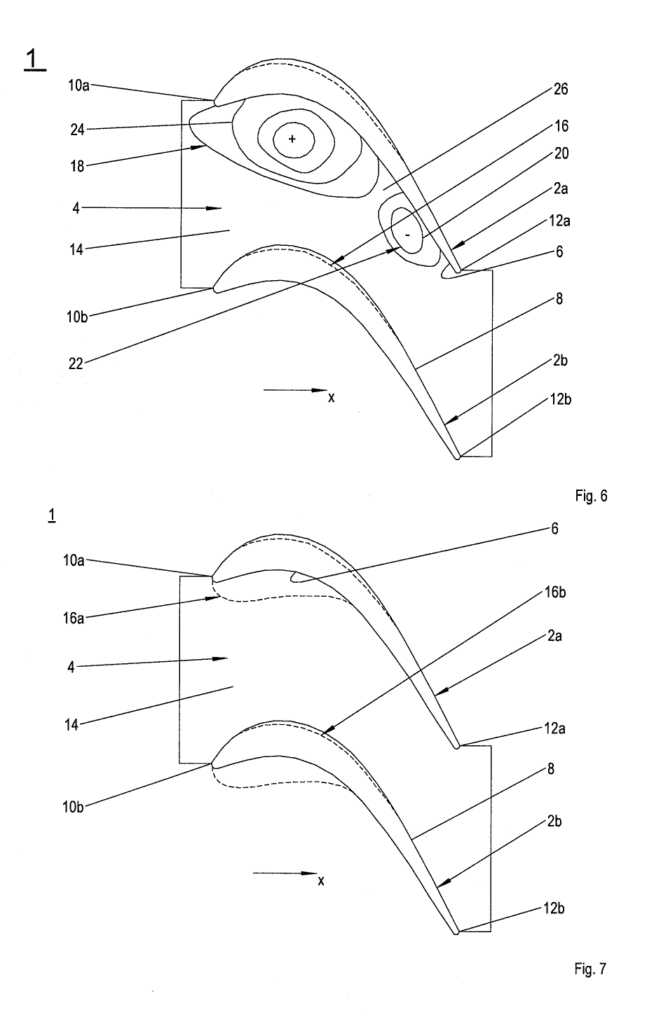

In the fourth exemplary embodiment of blade cascade 1 according to the present invention shown in FIG. 6, in contrast to the third exemplary embodiment according to FIG. 4 a second side wall contouring 22 is provided in a blade channel 4 between two blades 2a, 2b in addition to pressure-side side wall contouring 18 in the form of a projection and suction-side shape variation 16 in the form of an abrasion. Pressure-side side wall contouring 18 and suction-side shape variation 16 have the same design as in the third exemplary embodiment according to FIGS. 4, 5a, and 5b, so that detailed individual considerations of pressure-side side wall contouring 18 and of suction-side shape variation 16 are dispensed with to avoid repetitions.

Second side wall contouring 22 is an impression on the pressure side, and is graphically depicted by depth contour lines 20. The deepest section of the second side wall contouring, indicated by a minus sign, is situated at a distance from suction side 8 and is oval, for example. The second side wall contouring is preferably separated from projection 18 by a contour-free side wall section 26, and ends axially upstream from trailing edge 12a of blade 2a.

FIG. 7 shows one exemplary embodiment of a blade cascade 1 according to the present invention, having a plurality of blade channels 4 whose adjacent blades 2a, 2b have a shape variation 16a, 16b, respectively. Shape variation 16a of the one blade 2a has a design in the side wall area corresponding to shape variation 16 according to FIGS. 1, 2a, 2b, and 3. Shape variation 16b of the other blade 2b has a design in the side wall area corresponding to shape variation 16 according to FIGS. 4, 5a, 5b, and 6.

The one shape variation 16a is a thickened area of pressure side 6 of blade 2a, and extends downstream from leading edge 10a to approximately 50% of the axial width of blade 2a. Thickened area 16a preferably has a radial extension of up to approximately 15% of a blade channel height. As indicated by the dashed line, the thickened area has a profile-like curve and is formed on pressure side 6, near inner side wall 14. Due to its extension into the blade channel, the thickened area causes a reduction in the channel cross section in the area near the side wall.

The other shape variation 16b is an abrasion or cutout of suction side 8 of blade 2b, and extends downstream from leading edge 10b in an area of approximately 10% to 75% of the axial blade width. Abrasion 16b preferably has a radial extension of up to approximately 15% of a blade channel height. As indicated by the dashed line, the abrasion has a profile-like curve and is formed on suction side 8, near side wall 14. Due to its extension into blade channel 4, the thickened area causes a reduction in the channel cross section in the area near the side wall, i.e. at the side wall.

It is noted that shape variations 16, 16a, 16b of the blade profile, i.e., the respective specific configuration of pressure side 6 or of suction side 8, relate(s) to designs with and also without a fillet in all exemplary embodiments in the side wall area.

A blade cascade of a turbomachine having at least one shape variation of a blade situated on the blade side in the proximity of a side wall and extending downstream, and at least one side wall contouring of the side wall or at least one second shape variation of an adjacent blade near the side wall, as well as a turbomachine, are disclosed.

### LIST OF REFERENCE NUMERALS

1 blade cascade
2a, b blade
4 blade channel
6 pressure side
8 suction side
10a, b leading edge
12a, b trailing edge
14 inner side wall
16, 16a, 16b shape variation
18 side wall contouring
20 depth contour line
21 unchanged lateral curve
22 side wall contouring
24 height contour line
26 contour-free side wall section
114 outer side wall
x axial direction

What is claimed is:

1. A blade cascade of a turbomachine, the blade cascade comprising:
a plurality of blade channels in a peripheral direction delimited in each case by a pressure side of a blade and by an oppositely situated suction side of an adjacent blade, and in a radial direction delimited in each case by two oppositely situated side walls,
at least one side wall of the blade channels in each case having at least one circumferentially asymmetrical side wall contouring in an area of one of the blade and the adjacent blade, the other of the blade and the adjacent blade in a pressure side or suction side area facing the side wall contouring having at least one shape variation extending downstream, at the side wall, the shape variation being an abrasion or cutout of the suction side.

2. The blade cascade as recited in claim 1 wherein the abrasion or cutout has a radial extension from the side wall up to 15% of a blade channel height.

3. The blade cascade as recited in claim 1 wherein the abrasion or cutout beings downstream from the leading edge.

4. The blade cascade as recited in claim 3 wherein the abrasion or cutout extends in an area of 10% to 75% of the axial blade width.

5. The blade cascade as recited in claim 1 wherein the at least one side wall contouring includes a projection on the pressure side.

6. The blade cascade as recited in claim 5 wherein the projection begins upstream from the leading edge on the pressure side.

7. The blade cascade as recited in claim 5 wherein a further side wall contouring in the form of a pressure-side impression is situated downstream from the side wall contouring.

8. A turbomachine comprising the blade cascade as recited in claim 1.
